(19) United States
(12) Patent Application Publication
(10) Pub. No.: US 2015/0183037 A1
(43) Pub. Date: Jul. 2, 2015

(54) BAND SAW MACHINE CAPABLE OF REGULATING BAND-SAW CUTTING SPEED

(71) Applicant: National Chung Cheng University, Chia-Yi County (TW)

(72) Inventors: Yeau-Ren JENG, Tainan City (TW); Yu-Xian HUANG, Tainan City (TW)

(73) Assignee: National Chung Cheng University, Chia-Yi County (TW)

(21) Appl. No.: 14/146,612

(22) Filed: Jan. 2, 2014

(51) Int. Cl. B23D 59/00; B23D 55/06; B23D 55/10; B23D 53/02

(52) U.S. Cl. CPC B23D 59/001; B23D 53/02; B23D 55/065; B23D 55/10

(57) ABSTRACT

A band saw machine includes a working bench, a motor mounted to the working bench, a driving wheel mounted to the working bench and connected with the motor, a driven wheel mounted to the working bench, a band saw running on the driving and driven wheels, and a force sensor mounted to a driven wheel for sensing how much the driven wheel is forced in the process of cutting and for emitting a sensing signal to a control system. In this way, the control system can receive the sensing signal and control the running speed of the motor according to the sensing signal to adjust the cutting speed of the band saw.

### BACKGROUND OF THE INVENTION

1. Field of the Invention

The present invention relates generally to a band saw and more particularly, to a band saw capable of regulating band-saw cutting speed.

2. Description of the Related Art

Generally speaking, while operating the band saw machine to cut a workpiece, a user needs to adjust the cutting speed of the band saw according to the texture of the work piece. For example, if the workpiece is soft-textured, such as wood, the workpiece can be cut more quickly; if the workpiece is hard-textured, such as metal, the workpiece can be cut more slowly. In this way, the band saw can be prevented from rupture and have higher cutting efficiency.

Taiwan Patent Pub. No. M338123 disclosed that a frequency converter is to adjust the rotary speed of the motor to indirectly adjust the speed of the band saw and a display device is to show the power frequency or the rotary speed of the motor. However, the data presented by the frequency converter is not the actual cutting speed of the band saw. For the user, it is possible to incorrectly interpret the data, so the cutting speed of the band saw may fail to be properly adjusted to further adversely affect the cutting efficiency and service life of the band saw.

### SUMMARY OF THE INVENTION

The primary objective of the present invention is to provide a band saw machine, which can adjust the band-saw cutting speed to enhance the band-saw cutting efficiency and service life.

The foregoing objective of the present invention is attained by the band saw machine formed of a working bench, a motor, a driving wheel, a driven wheel, a band saw, at least one force sensor, and a control system. The motor is mounted to the working bench and includes a driving shaft. The driving wheel is rotatably mounted to the working bench and connected with the driving shaft for rotation driven by the motor.

The driven wheel is rotatably mounted to the working bench via a rotary shaft. The bans saw runs on the driving and driven wheels for cutting a workpiece. The at least one force sensor is mounted to the rotary shaft for sensing how much a force is applied to the driven wheel in the process of cutting and for emitting a sensing signal. The control system is electrically connected with the motor and the at least one force sensor for receiving the sensing signal of the force sensor and controlling power output of the motor to the driving wheel according to the sensing signal.

In light of the structure mentioned above, the band saw machine of the present invention can adjust the cutting speed of the band saw in real time to maintain the force required for the cutting of the band saw to effectively enhance the cutting efficiency and service life of the band saw.

### BRIEF DESCRIPTION OF THE DRAWINGS

FIG. 1 is a front view of a preferred embodiment of the present invention.

FIG. 2 is a partially rear view of the preferred embodiment of the present invention.

FIG. 3 is a block diagram view of the preferred embodiment of the present invention.

### DETAILED DESCRIPTION OF PREFERRED EMBODIMENTS

Structural features and desired effects the present invention will become more fully understood by reference to a preferred embodiment given hereunder. However, it is to be understood that the embodiment is given by way of illustration only, thus is not limitative of the claim scope of the present invention.

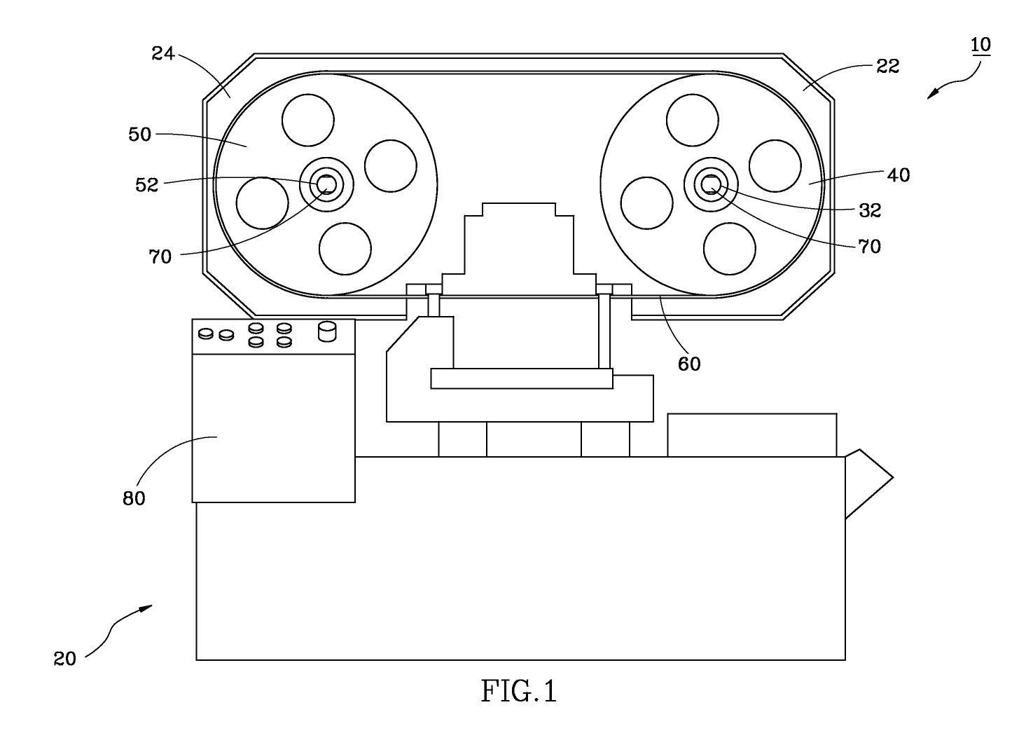

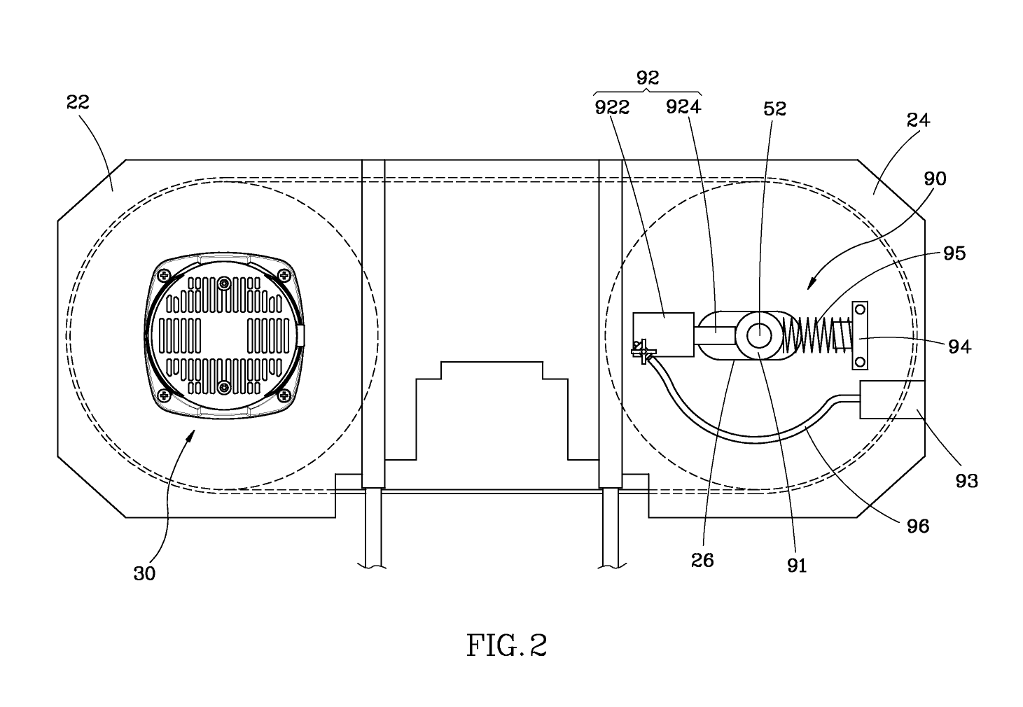

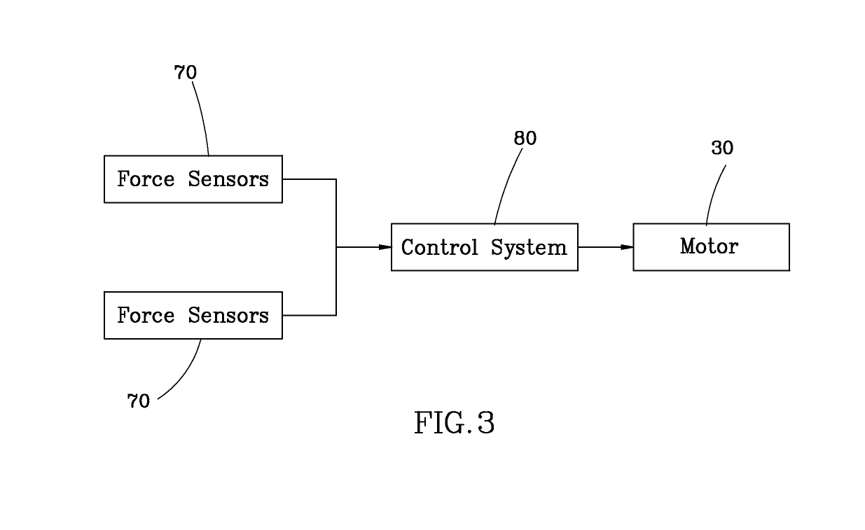

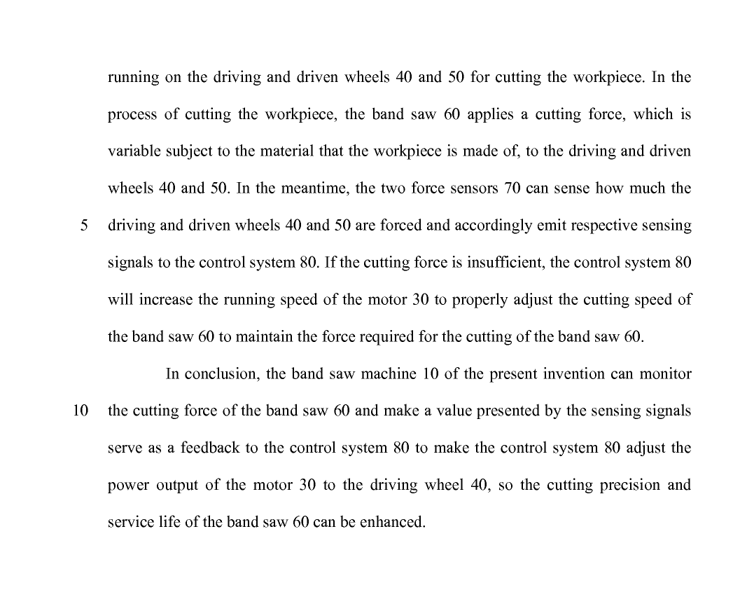

Referring to FIGS. 1 and 2, a band saw constructed according to a preferred embodiment of the present invention is formed of a working bench 20, a motor 30, a driving wheel 40, a driven wheel 50, a band saw 60, two force sensors 70, and a control system 80. The detailed descriptions and operations of these elements as well as their interrelations are recited in the respective paragraphs as follows.

The working bench 20 includes a driving-wheel holder 22 and a driven-wheel holder 24 relative to the driving-wheel holder 22. The driven-wheel holder 24 includes a slot 26.

The motor 30 is installed to a backside of the driving-wheel holder 22 for providing a power source. The motor 30 includes a driving shaft 32 extending into the driving-wheel holder 22.

The driving wheel 40 is mounted inside the driving-wheel holder 22 and connected with the driving shaft 32. The driving wheel 40 can be driven by the motor 30 for rotation.

The driven wheel 50 is rotatably mounted inside the driven-wheel holder 24 relative to the driving wheel 40 via a rotary shaft 52.

The band saw 60 runs on the driving wheel 40 and the driven wheel 50 for cutting a workpiece (not shown).

The two force sensors 70 are mounted to the driving shaft 32 and the rotary shaft 52, respectively, for sensing how much the driving wheel 40 and the driven wheel 50 are forced in the process of the cutting, respectively, and then for emitting respective sensing signals. It is to be noted that the number of the force sensor 70 does not need to be two and can be one only as long as it is mounted to the rotary shaft 52 of the driven wheel 50.

The control system 80 is mounted to the working bench 20 and electrically connected with the motor 30 and the two force sensors 70 for receiving the sensing signals and for controlling the rotary speed of the motor 30 according to the sensing signals.

To properly adjust the tension of the band saw 60, the band saw machine 10 of the present invention further includes a tension regulation device 90. The tension regulation device 90 is formed of a slide member 91, a hydraulic cylinder 92, a storage member 93, a stop member 94, and a resilient member 95. The slide member 91 is slidably mounted inside the slot 26. The hydraulic cylinder 92 includes a cylinder body 922 and a piston rod 924. The cylinder body 922 is fixed to a backside of the driven-wheel holder 24. The piston rod 924 includes two ends, one of which is mounted inside the cylinder body 922 and the other pushes and contacts against the slide member 91, while elongating, to make the driven wheel 50 move along the slot 26 relative to the driving wheel 40 through the slide member 91 for tightening or loosening the band saw 60. The storage member 93 is fixed to a backside of the working bench 20 for storage of hydraulic oil (not shown) and is connected with the cylinder body 922 via an oil tube 96 to make the hydraulic oil b be transported to the cylinder body 922 to further force the piston rod 924 to elongate. The stop member 94 is fixed to the backside of the working bench 20. The resilient member 95 is mounted between the slide member 91 and the stop member 94 for pushing the slide member 91 to make the driven wheel 50 move toward the hydraulic cylinder 72 for conveniently loosening the band saw 60.

As known from the structure mentioned above, when the driving wheel 40 is driven by the motor 30 to initiate rotation, the band saw 60 can be towed synchronously to drive the driven wheel 50 to rotate synchronously to make the band saw 60 keeping

What is claimed is:

1. A band saw machine capable of regulating cutting speed, comprising:
a working bench;
a motor mounted to the working bench and having a driving shaft;
a driving wheel rotatably mounted to the working bench and connected with the driving shaft of the motor for making the driving wheel be driven by the motor for rotation;
a driven wheel rotatably mounted to the working bench via a rotary shaft;
a band saw running on the driving and driven wheels;
at least one force sensor mounted to the rotary shaft of the driven wheel for sensing how much the driven wheel is forced in the process of cutting and for emitting a sensing signal; and
a control system electrically connected with the motor and the force sensor for receiving the sensing signal of the force sensor and controlling power output of the motor to the driving wheel.

2. The band saw machine as defined in claim 1, wherein said at least one force sensor is two in number and the two force sensors are mounted to the driving shaft of the motor and the rotary shaft of the driven wheel, respectively.

3. The band saw machine as defined in claim 1, wherein the working bench comprises a slot and a tension regulation device, the tension regulation device having a slide member, a hydraulic cylinder, and a storage member, the slide member being slidably mounted to the slot and connected with the rotary shaft of the driven wheel, the hydraulic cylinder having a cylinder body and a piston rod, the cylinder body being fixed to the working bench, the piston rod having two ends, one of which is mounted to the cylinder body and the other pushes and contacts against the slide member, the storage member being connected with the cylinder body via an oil tube.

4. The band saw machine as defined in claim 2, wherein the working bench comprises a slot and a tension regulation device, the tension regulation device having a slide member, a hydraulic cylinder, and a storage member, the slide member being slidably mounted to the slot and connected with the rotary shaft of the driven wheel, the hydraulic cylinder having a cylinder body and a piston rod, the cylinder body being fixed to the working bench, the piston rod having two ends, one of which is mounted to the cylinder body and the other pushes and contacts against the slide member, the storage member being connected with the cylinder body via an oil tube.

5. The band saw machine as defined in claim 3, wherein the tension regulation device further comprises a stop member and a resilient member, the stop member being fixed to the working bench, the resilient member being mounted between the slide member and the stop member for pushing the slide member to make the driven wheel move toward the hydraulic cylinder.
